(19) United States
(12) Patent Application Publication
(10) Pub. No.: US 2006/0248443 A1
(43) Pub. Date: Nov. 2, 2006

(54) System and method for exporting spreadsheet data

(75) Inventor: Ramin Bagheri, Schwetzingen (DE)

Correspondence Address: KENYON & KENYON LLP, ONE BROADWAY, NEW YORK, NY, 10004, US

(73) Assignee: SAP Aktiengesellschaft

(21) Appl. No.: 11/115,822

(22) Filed: Apr. 27, 2005

(51) Int. Cl. G06F 17/00

(52) U.S. Cl. 715/503

(57) ABSTRACT

Exporting data from a database to a spreadsheet application is performed without losing the spreadsheet formatting by having the data in the spreadsheet application, the tabular data, locally formatted. In accessing a database through a portal application, data is retrieved therefrom. This data is formatted in accordance with database itself and includes formatting codes for translating the database data into a spreadsheet application. A local spreadsheet application resident with the portal application generates the tabular data displayed in the local spreadsheet application. As this tabular data is locally formatted, selected portions of the tabular data may be selected and exported to an external spreadsheet application. As this data export is between two spreadsheet applications running on the same processing device, the spreadsheet formatting of the tabular data is not lost.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

The present invention relates generally to accessing data in a database and more specifically to exporting data from a database application.

In existing database applications, data may be conveniently disposed in tabular format. Often times, tabular format provides direct benefits for not only compiling and cataloging data, but also for viewing data. Common spreadsheet applications may be used with conventional database applications. Thereupon, the data is translated for populating the spreadsheet application. When a user accesses the database and retrieves the data, the data may be presented in a viewable tabular format in any suitable spreadsheet application.

With managing large databases, such as an ERP database, one critical element is user access. For security reasons, database applications need to monitor outside access to databases. Therefore, a common concern is the manner in which a user is provided access.

There are many techniques for providing user access to a database. Previously, common techniques included allowing a user to directly dial in to a dedicate phone line for a direct connection. Other techniques include providing dedicated terminals at specific locations where the terminals have dedicated access to the database.

With external clients accessing a database, problems arise with not only securing the access to the database, but also how the access is granted. Recent developments allow for users to have secure access to a database using a direct network connection using a portal application or any other application having a portal user interface, such as a web browser application. Therefore, a normal user having a web browser application and the accompanying security measures may access the database directly on the user's computer.

With the web browser application, the display simulates a database viewer providing a replicated view of a standard database access. In the example of tabular data, the data is displayed without tabular formatting local to the web browser itself. In other words, the data may be formatted on the database side and only the full spreadsheet image is provided to the web browser. The tabular data displayed on the web browser application fails to contain any resident spreadsheet formatting.

With browser applications being operable with local applications, such as a word processing or a spreadsheet application, current web browsers often locally launch the accompanying applications for particular users. For example, if a word processing file is accessed using the web browser application, a local version of the word processing application may be launched inside the browser application. Therefore, a user may use the word processing application within the browser application.

Although, with locally launched applications, the data for the particular file must be preformatted for that application. For example, word processing elements, such as text and figures, must be formatted for the particular word processing application, otherwise it is stripped of any formatting before being viewable. Therefore, aspects to the data in a data file may be lost when transferred to an application local to the web browser.

In current database systems, tabular-formatted data is formatted resident to the database itself. When the browser application views the data, it does not include any tabular formatting local to the browser. A user is unable to transfer tabular data using a data copy technique while maintaining data formatting. Rather, a user may duplicate the raw, unformatted data, but it will not accurately maintain resident formatting.

One direct benefit of data access is transferring tabular data to a spreadsheet application resident on the user's desktop. For example, a user may access tabular data in the database and then transfer that data to their desktop application, such as for running reports or viewing the data when not connected to the database. In current systems, since the formatting of the tabular data is resident to the database itself, the transfer of any tabular data would result in the removal of all tabular formatting. When the data is imported into a user's desktop spreadsheet application, the data would not have any formatting.

For example, the tabular formatting that is lost may include not only textual formatting, such as font size, font type, character spacing, etc, but other elements, such as mathematical functions, for example the summation of a particular column. This formatting is lost when data is exported out of a portal application into an external application running on a desktop.

### BRIEF DESCRIPTION OF THE DRAWINGS

FIG. 1 illustrates a block diagram of one embodiment of a system for exporting spreadsheet data.

FIG. 2 illustrates a graphical representation of the data processing by an apparatus for exporting spreadsheet data.

FIG. 3 illustrates a representative screenshot of a local spreadsheet application having tabular data in a portal application.

FIG. 4 illustrates a representative screenshot of selected portion of the tabular data.

FIG. 5 illustrates a representative screenshot of an import command window associated with an external spreadsheet application.

FIG. 6 illustrates a representative screenshot of the selected portion of the tabular data in the external spreadsheet application.

FIG. 7 illustrates a flow chart of the steps of one embodiment of a method for exporting spreadsheet data.

FIG. 8 illustrates a flow chart of the steps of another embodiment of a method for exporting spreadsheet data.

### DETAILED DESCRIPTION

When accessing data from a remote server through a local processing device, a portal application is used on the local processing device. The portal application provides an interface for accessing the remote server and accessing data on that remote server. Although, the portal application may also include further data access or usage applications that include a user interface for allowing user access. Through the portal application, acquired data may be exported to a local application without losing the data formatting if the data formatting is local to the portal application. The local application is an application being executed within the portal application itself. When accessing the database through the portal application, the data is retrieved with formatting codes. Using these formatting codes with the local application, the data is then formatted locally using the portal application. The data may then be extracted, such as using a copy function with the portal application, for copy not only the data itself, but also the underlying formatting. The copy function allows for distributing the formatted data to a remote application, remote to the portal application, operating on the local processing device, without losing the proper formatting.

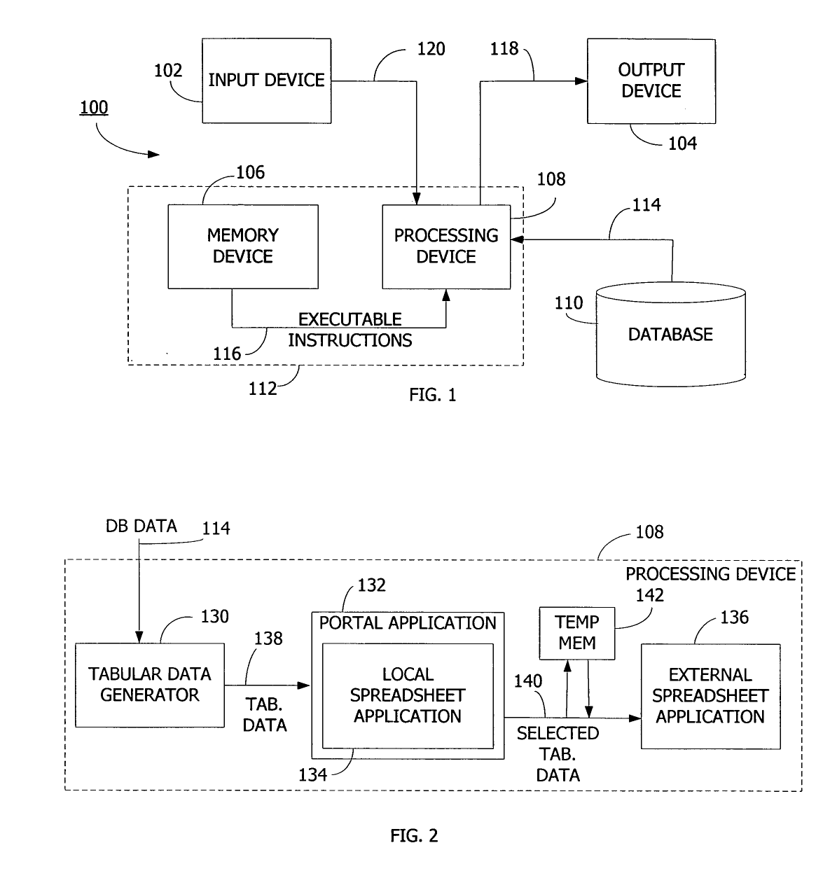

FIG. 1 illustrates one embodiment of a system 100 for exporting spreadsheet data. The system 100 includes an input device 102, an output device 104, a memory device 106, a processing device 108 and a database 110. In one embodiment, the memory device 106 and the processing device 108 may be an apparatus 112 exporting spreadsheet data, wherein the apparatus 112 works in conjunctions with the database 110 and may include or work in conjunction with the input device 102 and the output device 104.

In one embodiment, the system 100 exports spreadsheet data by the processing device 108 accessing the database 110. The database access may be a data retrieval request in accordance with known data access techniques. The processing device 108 and the database 110 may be in direct communication across a dedicated network, but may also be in communication across a public accessible network, such as an internet connection, with the appropriate security measures.

The processing device 108 receives database data 114 that includes formatting codes. The database data 114 may be any suitable representation of the data itself as stored within the database 110 and the formatting codes provide formatting information as to the specific data elements as well as any overall formatting information, such as mathematical formulas or other underlying features associated with the data. For example, the database data 114 may be raw un-formatted data in a particular sequence and the formatting codes provide font information and ordering information for the data in particular rows and columns.

The processing device 108 receives executable instructions 116 from the memory device 106 and performs the noted functions in response to these executable instructions. In a typical operating format, the processing device 108 has already launched a portal application, such as a browser application or a data management application having browser interface capabilities. The processing device 108 provides an output signal 118 to the output device 104, such as a display for a visual output. In normal operations, the processing device 108 provides the output signals 118 to the output device 104 in response to user input 120 received from the input device 102. Therefore, a feedback system exists for a user operating the apparatus 112.

FIG. 2 illustrates a further graphical representation of the processing device 108. As represented in block format, the processing device 108 launches several applications, such as a tabular data generator 130, a portal application 132 having a local spreadsheet application 134 executed therein and an external spreadsheet application 136.

As described with reference to both FIGS. 1 and 2, in one embodiment, the processing device 108 launches the local spreadsheet application 134 within the portal application 132. This local spreadsheet application 134 is similar to the external spreadsheet application 136, except that the local spreadsheet application 134 is executed within the portal application 132, allowing a user to see both the portal application functions, such as navigating between screens or resource locations, and use the spreadsheet application therein.

Consistent with launching the spreadsheet application, the processing device generates tabular data 138 based on the database data 114 having the formatting codes. The generation of tabular data 138 may be performed by following the formatting codes as instructions for assembling the database data, such as formatting particular data fields and assigning other functionalities, such as a mathematical formula, to the appropriate data elements. While FIG. 2 illustrates the tabular data generator 130 separately, it is understood that this generator 130 may be incorporated directly within the local spreadsheet application 134 or any other application generating the tabular data 138 from the database data 114.

After the tabular data 138 is generated, the processing device 108 inserts the tabular data into the local spreadsheet application 134 within the portal application 132. It is recognized that the insertion of this tabular data 138 may be performed as the tabular data 138 is generated or upon completion of the generation step. The portal application 132 includes the local spreadsheet application 134 providing a viewable display through an output signal 118 to the output device 104 of FIG. 1.

In response to a data selection command (user input 120) from the input device 102, a portion of the tabular data is selected. This selected tabular data 140 may then be exported to the external spreadsheet application 136. In the selection of the tabular data 140 from the local spreadsheet application 134, the selected tabular data 140 maintains the spreadsheet formatting. In other words, the formatting generated by the tabular data generator 130 in generating the tabular data 138 is included in the export function. Since the export of the selected tabular data 140 is from two spreadsheet applications 134, 136 on the same processing device 108, the spreadsheet formatting is maintained.

The selected tabular data 140 is visible in the external spreadsheet application 136, which may be visible in a secondary display or application window on the output device 104. In another embodiment, a temporary memory location 142 may be used to temporarily store the selected tabular data 140. The temporary memory location 142 may be any suitable memory device available to the processing device 108, such as a clipboard for temporarily storing the selected tabular data 140. In one embodiment, the temporary memory location may be used based on the processing device 108 switching between processing functions for the portal application 132 running the local spreadsheet application 134 and the external spreadsheet application 136.

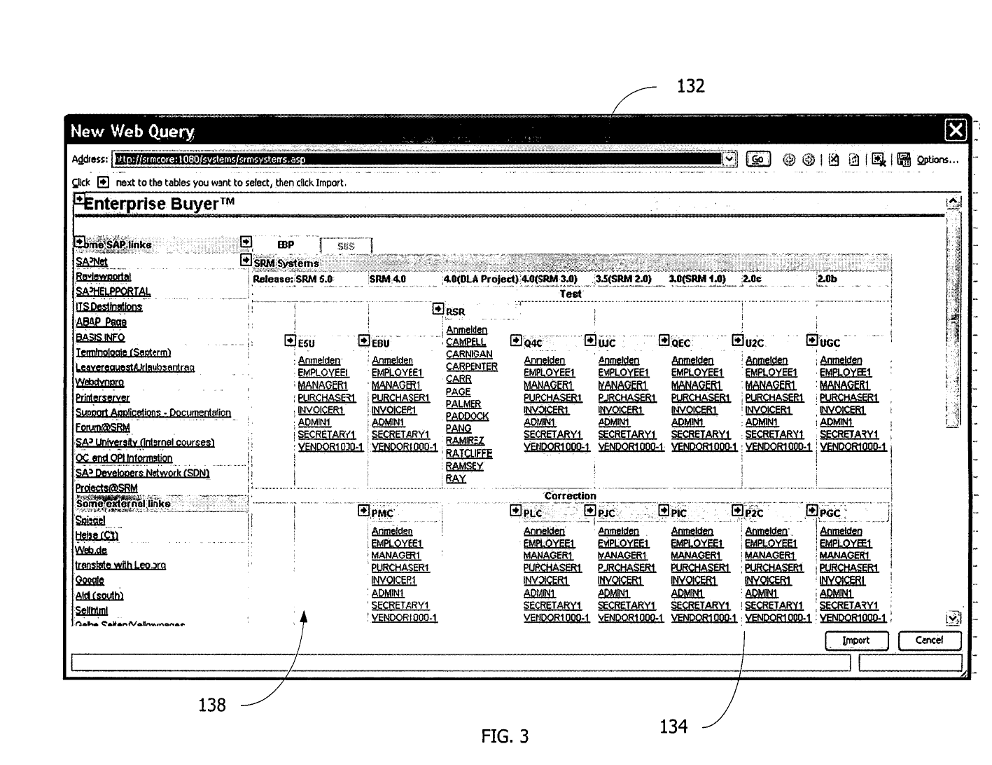

FIG. 3 illustrates a representative screenshot of one embodiment of a display of the portal application 132 having a local spreadsheet application 134 executed therein. The portal application 132 accesses a database (such as database 110 of FIG. 1) to extract the database data with formatting codes. Based on these codes, the processing device generates the tabular data 138 shown in the display. With respect to FIG. 1, the screenshot of FIG. 3 is visible on the output device 104 in response to an appropriate output signal 118.

As visible in the screen shot of FIG. 3, the local spreadsheet application 134 includes multiple columns of tabular data 138. Whereas this tabular data 138 represents a large volume of information, a user may wish to extract a selected portion of the tabular data. Although, in extracting the data, maintaining the spreadsheet formatting allows for the data to be quickly and efficiently used in spreadsheet applications outside of the portal application 132.

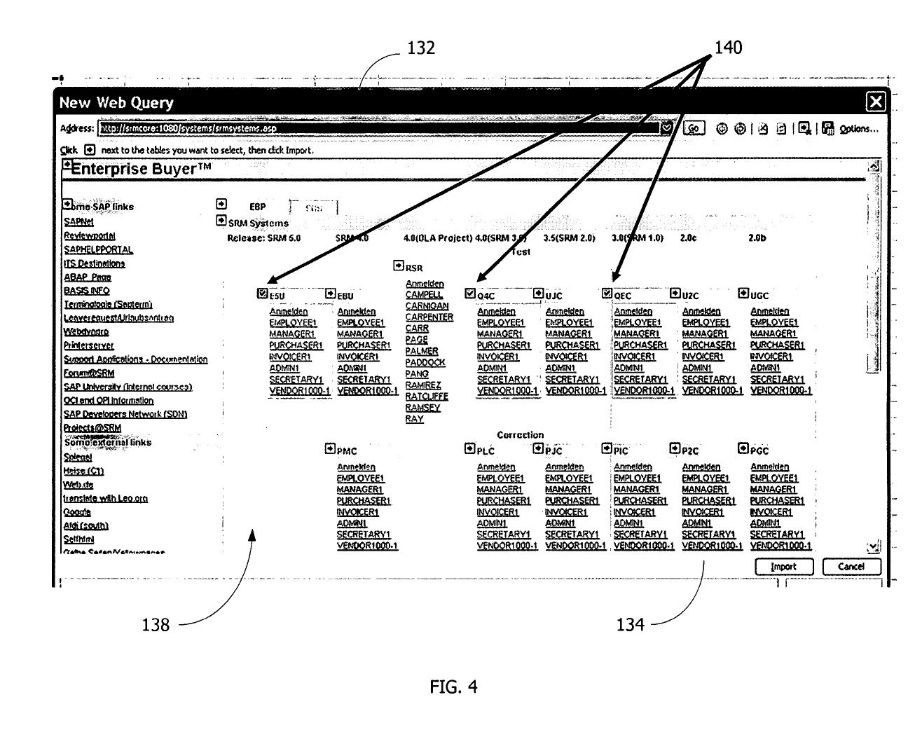

FIG. 4 illustrates a screenshot of the selection of selected tabular data 140 amongst the tabular data 138 displayed in the local spreadsheet application 134 in the portal application 132. In one embodiment, selection identifiers are disposed relative to the columns of selected tabular data 140 to indicate their selection. For example, a user may select the indicator to select a full column. A user may select a portion of data using a cursor or other commands, or any other suitable technique for selecting data.

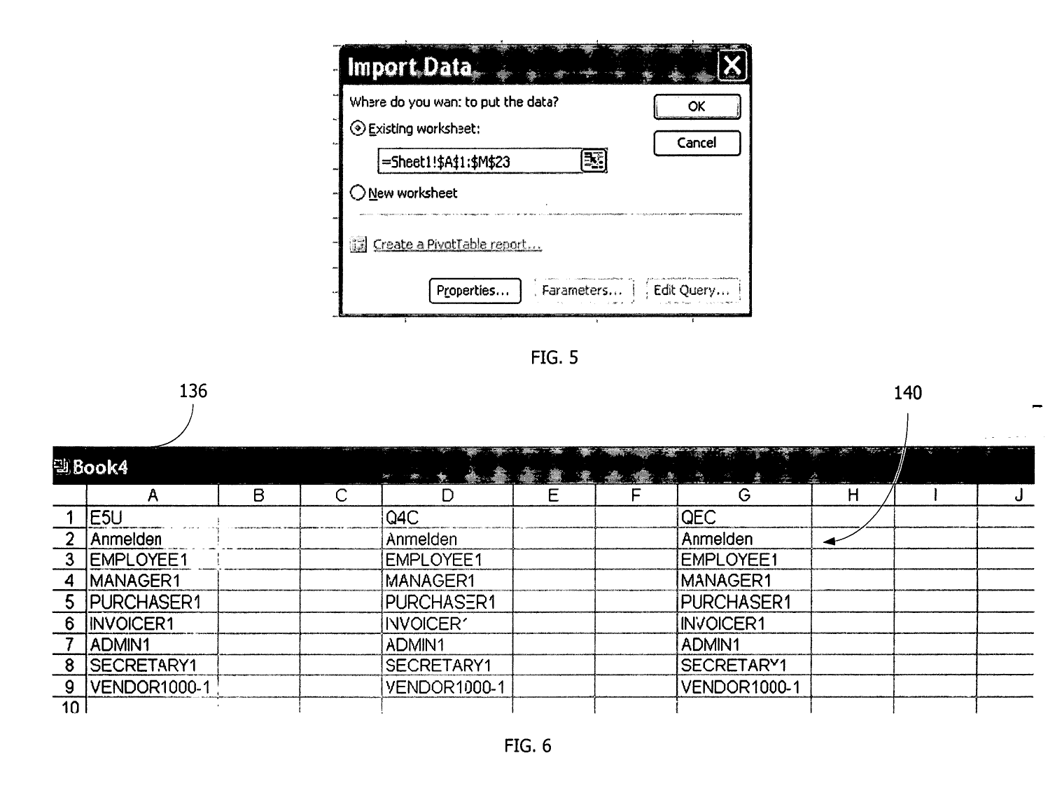

FIG. 5 illustrates a screenshot of an input display for the external spreadsheet application 136. In one embodiment, the external spreadsheet application 136 provides a visual display illustrating the portions of selected tabular data 140 to be exported from the local spreadsheet application. In the external spreadsheet application 136, the user may accept the data import command to create or add to an existing spreadsheet display.

FIG. 6 illustrates a screenshot of the exported selected tabular data 140. The data 140 is disposed in a worksheet or other display within the external spreadsheet application 136. This data 140 maintains its spreadsheet formatting, allowing a user to utilize the data in any suitable manner without having to recreate any previous formatting.

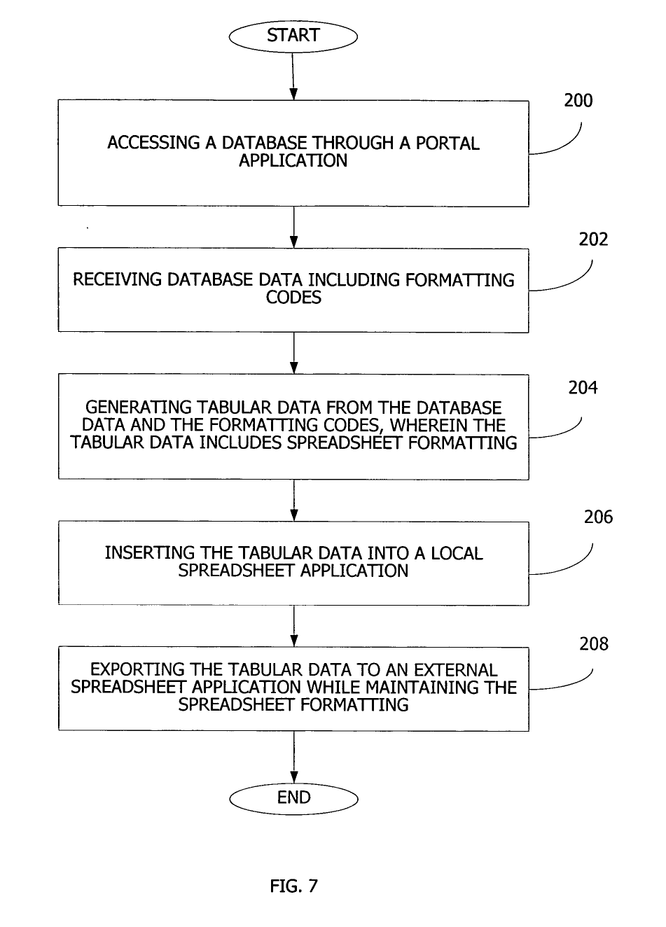

FIG. 7 illustrates the steps of one embodiment of a method for exporting data from a spreadsheet application. The method begins, step 200, by accessing a database through a portal application. With respect to FIGS. 1 and 2, a portal application 132 running on a processing device 108, in response to executable instructions 116, accesses the database 114. The next step, step 202, is receiving database data including formatting codes. As discussed above, the formatted codes include directions for converting the data from the database format, the format in which that data is stored within the database, to a format for being displayed on a spreadsheet application.

The next step, step 204, is generating tabular data from the database data and the formatting the codes, wherein the tabular data includes spreadsheet formatting. Based on this step, the database data is now formatted for viewing in a spreadsheet application. The next step, step 206, is inserting the tabular data into a local spreadsheet application. Once the formatting is complete, the data may be written to the application or the application may read the tabular data from a memory location. Regardless thereof, the tabular data is associated with the local spreadsheet application running in conjunction with the portal application used to access the database.

The next step, step 208, is exporting the tabular data to an external spreadsheet application while maintaining the spreadsheet formatting. As noted above in FIG. 2, the selected tabular data 140 includes the spreadsheet formatting associated therewith. When the data itself is exported, the spreadsheet formatting is included in the data export. Therefore, the external spreadsheet application 136 receives data similar to the tabular data 138 received by the local spreadsheet application 134, only that the selected tabular data 140 may be just a portion of the tabular data 138 instead of the full database data 114. As such, the method provides exporting data from a spreadsheet application running in a portal application, the spreadsheet application being a local spreadsheet application, while maintaining the spreadsheet formatting of the selected tabular data. Thereupon, the method is complete.

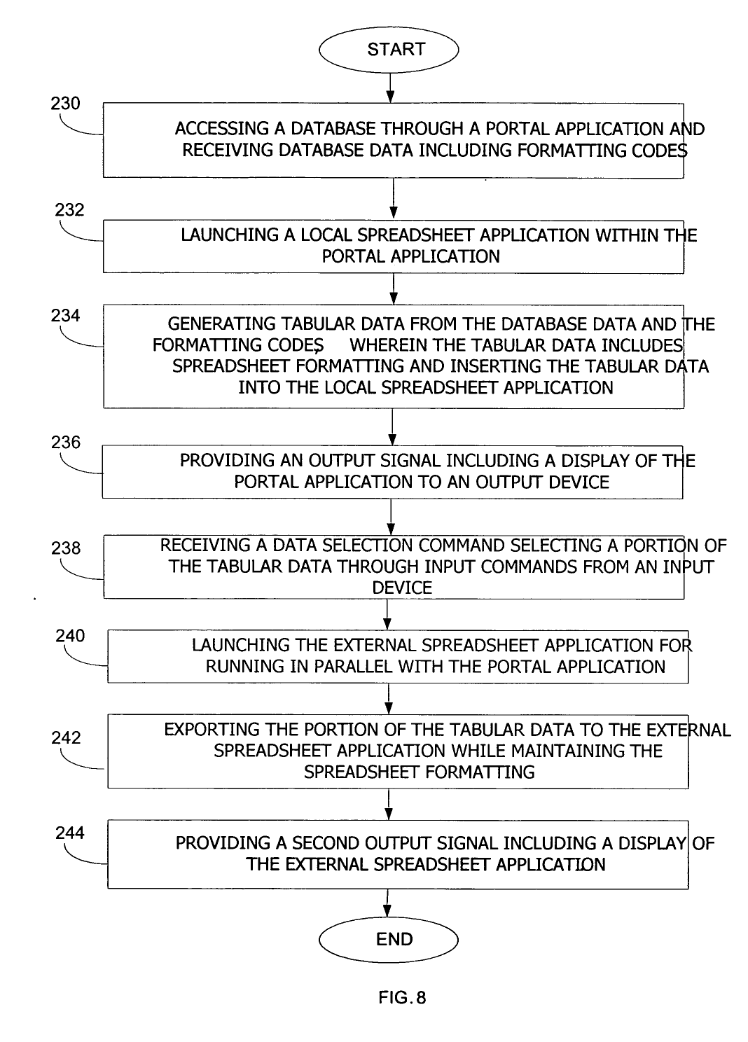

FIG. 8 illustrates another embodiment of a method for exporting spreadsheet data. The method begins, step 230, accessing a database through a portal application and receiving database data including formatting codes. Step 230 is similar to steps 200 and 202 of the method described above in FIG. 7. The next step, step 232, is launching a local spreadsheet application within the portal application. As described above with respect to FIG. 2, the local spreadsheet application 134 is launched by the processing device 108 within the portal application 132, such as a web browser application. The launched local spreadsheet application 132 operates within the browser application, allowing for spreadsheet functionality associated data or information access by the portal application 134.

The next step, step 234, is generating tabular data from the database data and the formatting codes, wherein the tabular data includes spreadsheet formatting and inserting the tabular data into the local spreadsheet application. Step 234 is similar to steps 204 and 206 of the method described above in FIG. 7. The next step, step 236, is providing an output signal including a display of the portal application to an output device. In one embodiment, the processing device 108 provides the output signal 118, which is provided to the output device 104, such as a display device providing a visual display of the portal application having the local spreadsheet application and tabular data thereon, such as shown in the screenshot of FIG. 3.

The next step, step 238, is receiving a data selection command selecting a portion of the tabular data through input commands from an input device. This step may be performed through the receipt of input commands 120 from the input device 102, whereupon the processing device correspondingly selects a portion of the tabular data. In another example, FIG. 4 illustrates one embodiment of a screen shot showing the selected portions of the tabular data.

The next step, step 240, is launching the external spreadsheet application for running in parallel with the portal application. As describe above with respect to FIG. 2, the processor 108 launches the external spreadsheet application 136, which may be similar to the local spreadsheet application 134 without being resident within the portal application 132. The next step, step 242, is exporting the portion of the tabular data to the external spreadsheet application while maintaining the spreadsheet formatting. As the data being exported to the external spreadsheet application is between similar spreadsheet applications running on the same processing device 108, standard export techniques may be used, where these export techniques include exporting the accompanying formatting for the tabular data elements. Therefore, when the data transfer is complete, as the conversion from database formatting to spreadsheet application formatted was performed locally on the processing device, formatting characteristics are not lost. As such, in this embodiment, the method is complete.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exists implementations of other variations and modifications of the invention and its various aspects, as may be readily apparent to those of ordinary skill in the art, and that the invention is not limited by specific embodiments described herein. For example, the electronic version of the input file may be stored in any suitable location, including external to the database and does not have to be stored before matching and mapping the data to the database, wherein a link to the stored input file may be referenced in the database as any suitable time. It is therefore contemplated to cover any and all modifications, variations or equivalents that fall within the scope of the basic underlying principals disclosed and claimed herein.

What is claimed is:

1. An apparatus for exporting spreadsheet data, the apparatus comprising:
a memory having executable instructions stored therein; and
a processing device responsive to the executable instructions to:
access a database through a portal application;
receive database data including formatting codes;
generate tabular data from the database data and the formatting codes, wherein the tabular data includes spreadsheet formatting;
insert the tabular data into a local spreadsheet application; and
exporting the tabular data to an external spreadsheet application while maintaining the spreadsheet formatting.

2. The apparatus of claim 1, the processing device further operative to, in response to the executable instructions:
prior to writing the tabular data to the external spreadsheet, store the tabular data in a temporary memory location.

3. The apparatus of claim 1, the processing device further operative to, in response to the executable instructions:
launch the local spreadsheet application within the portal application; and
launch the external spreadsheet application for running in parallel with the portal application.

4. The apparatus of claim 1, the processing device further operative to, in response to executable instructions:
receive a data selection command selecting a portion of the tabular data; and
export the portion of the tabular data to the external spreadsheet application while maintaining the spreadsheet formatting.

5. The apparatus of claim 4 further comprising:
an input device coupled to the processing device and providing input commands to the processing device, wherein the input commands include the data selection command.

6. The apparatus of claim 1 further comprising:
an output device coupled to the processing device, the output device receiving an output signal including a display of the portal application.

7. The apparatus of claim 6, the output device receiving a second output signal including a display of the external spreadsheet application.

8. A method for exporting data from a spreadsheet application, the method comprising:
accessing a database through a portal application;
receiving database data including formatting codes;
generating tabular data from the database data and the formatting codes, wherein the tabular data includes spreadsheet formatting;
inserting the tabular data into a local spreadsheet application; and
exporting the tabular data to an external spreadsheet application while maintaining the spreadsheet formatting.

9. The method of claim 8 further comprising:
prior to writing the tabular data to the external spreadsheet, storing the tabular data in a temporary memory location.

10. The method of claim 8 further comprising:
launching the local spreadsheet application within the portal application; and
launching the external spreadsheet application for running in parallel with the portal application.

11. The method of claim 8 further comprising:
receiving a data selection command selecting a portion of the tabular data; and
exporting the portion of the tabular data to the external spreadsheet application while maintaining the spreadsheet formatting.

12. The method of claim 11 further comprising:
receiving input commands from an input device, wherein the input commands include the data selection command.

13. The method of claim 8 further comprising:
providing an output signal including a display of the portal application to an output device.

14. The method of claim 13 further comprising:
providing a second output signal including a display of the external spreadsheet application.

15. A system for exporting spreadsheet data, the system comprising:
a database having database data stored therein, the database data including formatting codes;
a processing device in operative communication with the database;
a memory device coupled to the processing device, the memory device having executable instructions stored therein;
an input device in operative communication with the processing device; and
the processing device, in response to executable instructions from the memory device operative to:
access the database through a portal application running on the processing device;
receive database data including formatting codes from the database;
generate tabular data from the database data and the formatting codes, wherein the tabular data includes spreadsheet formatting;
insert the tabular data into a local spreadsheet application;
receive a data selection command from the input device, the data selection command selecting a portion of the tabular data; and
export the portion of the tabular data to the external spreadsheet application while maintaining the spreadsheet formatting.

16. The system of claim 15, the processing device further operative to, in response to the executable instructions:
prior to exporting the portion of the tabular data to the external spreadsheet, store the portion of the tabular data in a temporary memory location.

17. The system of claim 15, the processing device further operative to, in response to the executable instructions:
launch the local spreadsheet application within the portal application; and
launch the external spreadsheet application for running in parallel with the portal application.

18. The system of claim 15 further comprising:
an output device coupled to the processing device, the output device receiving an output signal including a display of the portal application

19. The system of claim 18 further comprising:
the output device receiving a second output signal including a display of the external spreadsheet application.
